(19) United States
(12) Patent Application Publication
(10) Pub. No.: US 2022/0226083 A1
(43) Pub. Date: Jul. 21, 2022

(54) DENTAL MACHINE TOOL

(71) Applicant: IMES-ICORE GMBH, Eiterfeld (DE)

(72) Inventors: Christoph Stark, Eiterfeld (DE); Sebastian Ullrich, Eiterfeld (DE)

(21) Appl. No.: 17/614,637

(22) PCT Filed: May 28, 2020
(86) PCT No.: PCT/DE2020/000114

§ 371 Date: Nov. 29, 2021

(30) Foreign Application Priority Data
May 29, 2019 (DE) 20 2019 002 338.0

(51) Int. Cl. A61C 13/00

(52) U.S. Cl. CPC A61C 13/0004

(57) ABSTRACT

A dental machine tool includes a first dental machining unit with a first housing and a first machining head. The first housing accommodates a first machining space. The first machining head is arranged in the first machining space and a first machining zone is allocated to the first machining head. A second dental machining unit has a second housing and a second machining head. The second housing accommodates a second machining space. The second machining head is arranged in the second machining space. A second machining zone is allocated to the second machining head. A movable dental object carrier is constructed to receive a dental object and to move the dental object linearly along an X-axis. The movable dental object carrier extends over the first machining zone, the second machining zone and an intermediate zone between the first and second machining zones. The movable dental object carrier is constructed for executing: a first machining movement along the X-axis of the first machining zone, a second machining movement along the X-axis of the second machining zone; and a transport movement in the intermediate zone between the machining zones.

The invention relates to a dental machine tool for machining dental objects.

Various dental machine tools, which can machine a dental object using various technologies, are already known from the state of the art. According to the state of the art, special dental machine tools are provided for different processing steps and the blanks are subject to the processes in a suitable sequence in the different dental machine tools.

The task of the invention is to disclose a machine tool for dental objects, which provides fast and efficient machining and offers a high machining precision.

The task is solved by the features listed in Claim 1. Preferred developments result from the dependent claims.

According to the invention, the dental machine tool according to the invention has at least a first dental machining unit and a second dental machining unit as its basic components.

According to the invention, the first dental machining unit has a first housing and a first machining head.

The first housing forms a first machining space according to the invention. The first machining space is preferably completely enclosed by the first housing. In this way, the internal components are protected from external damage on the one hand and, on the other hand, the external environment is protected from contamination by machining by-products or from the risk of injury. Thus, a high level of occupational safety is achieved simultaneously.

The first housing preferably has a removable or openable part which provides access for maintenance or mounting work.

According to the invention, the first machining head is arranged in the first machining space. Preferably, it is controlled by the control unit of the dental machining tool.

According to the invention, a first machining zone is allocated to the first machining head. The first machining zone is the area in which the first machining head can act on a dental object and machine it. The spatial arrangement of the machining zone is defined by the position of the machining head and by the movement axes of the machining head and the dental object.

In the sense of the present application, a dental object is understood to be a dental prosthesis part, as well as a part or a preliminary machining stage of a dental prosthesis part. Thus, dental objects are in particular crowns, bridges, telescopes, bar constructions, abutments, primary dental crowns, secondary dental crowns, therapeutic splints as well as auxiliary constructions which serve to manufacture or use dental prostheses, such as templates or denture models.

According to the invention, the dental machine tool further comprises at least a second dental machining unit, the second dental machining unit comprising a second housing and a second machining head. The second dental machining unit is basically constructed in the same way as the first dental machining unit.

The second machining head is preferably developed by a different processing technology than the first machining head. Hereinafter, the processing technology will also be referred to in an abbreviated form as the technology. However, it is also possible that both machining heads are developed by means of the same technology. For example, it is also possible to have two machining heads that combine two milling tools with different properties, for example in terms of shape or roughness.

According to the invention, the second housing forms a second machining space in which the second machining head is arranged.

The two housings can be structurally connected to each other. Likewise, in special embodiments, the first housing can receive the second housing in its first machining space, and vice versa.

This design makes it possible to jointly receive and discharge liquid operating media such as, for example, a cooling lubricant or grinding fluid, which enables a simpler structural form.

According to the invention, a second machining zone is allocated to the second machining head. The second machining zone is the area in which the second machining head can act on the dental object and machine it. That means that the two machining zones are located in the respective machining space.

Moreover; the dental machining tool has a movable dental object carrier. The movable dental object carrier is designed to pick up a dental object and move it linearly in an X axis.

The movable dental object carrier comprises a stationary linear guide, for example a rail, which is arranged in an x axis, and a carrier, for example a carriage, which can be moved linearly on the stationary linear guide and has means for fixing a dental object to be machined. Preferably, the X axis is linear and the movable dental object carrier is designed as a translational dental object carrier.

The dental object is received by a latching or clamping device, which reversibly fixes the dental object at the movable dental object carrier.

According to the invention, the movable dental object carrier extends with its stationary linear guide over the first machining zone, over an intermediate zone between the two machining zones and over the second machining zone.

In the design disclosed, the movable dental object carrier extends along the X axis.

In the sense of the dental machine tool according to the invention, an X axis is to be understood as any possible movement axis which extends at least over a first and a second machining zone as well as at least over one intermediate zone. Thus, an X axis in the sense of the dental machine tool according to the invention exists even in particular if it could also be described as a Y axis or Z axis. In particular, the X axis is not defined to have a specific orientation in space. Furthermore, the X axis does not necessarily have to be straight in the geometric sense. In fact, the X axis can also be curved in sections or completely or describe a curve. In any case, the movable dental object carrier moves along a path on the X axis.

By extending over the first and second machining zones, the stationary linear guide simultaneously traverses both the first and second machining spaces. Each of the housings preferably has an opening which allows the dental object held by the workpiece carrier to be transported from one machining space to the other.

There is also an intermediate zone on the X axis, which is arranged between the two machining zones. This intermediate zone results from the structural separation of the two machining spaces so that the allocated machining zones are not directly adjacent to each other. In this intermediate zone, the dental object cannot be machined.

According to the invention, the movable dental object carrier is designed such that it carries out a first machining movement in the X axis of the first machining zone and a second machining movement in the X axis of the second machining zone. Moreover, the movable dental object carrier is designed such that it carries out a transport movement in the intermediate zone between the machining zones.

The exact positioning of the dental object relative to the machining head of the respective machining unit in its respective X axis is achieved by the machining movements.

Furthermore, the positioning of the dental object relative to the machining head is preferably carried out in further movement axes, wherein this can be done, depending on the design, by the machining head or by additional devices assigned to the movable dental object carrier. These axes can be translational or rotational movement axes. Preferably, the machining head executes at least one translatory movement axis in a Z axis by moving linearly back and forth to the dental object on the movable dental object carrier.

Thus, the dental machine tool according to the invention is firstly characterized in that the X axis machining movements of two dental machining units are provided by the movable dental object carrier, i.e., by one and the same constructive means. For this, the respective X axis position is processed by the control unit in the respective coordinate system of each dental machining unit and the movement of the movable carrier of the movable dental object carrier is triggered.

Secondly, the dental machine tool is characterized in that a mere transport movement is additionally provided by the movable dental object carrier, as is regularly performed by handling technology. Thus, the dental object carrier is additionally designed such that it moves the dental object back and forth between the two machining zones.

One advantage of the invention is that the dental object remains fixed in the movable dental object carrier when the machining technology is changed. This means that the system only has to define the position of the movable dental object carrier once and can transfer this position to a coordinate system which is uniform for the dental machine tool. The position remains known throughout the entire process. The resulting advantage of this is that there is no need to spend time for recalibration.

Another advantage is that the dental object can be machined by both dental machining units in one and the same clamping. Thus, the tolerances of the position of the dental object relative to the dental object carrier, which can finally never be completely avoided, are the same during machining in both dental machining units so that a particularly high precision of machining can be achieved relative to each other in the dental machining units.

Furthermore, this aspect eliminates the need for set-up and adjustment work, which is advantageous in terms of time saving.

Another advantage is given by cost reduction, since only one movable dental object carrier is required for both machining units. Only the stationary linear guide, which is usually a linear guide rail, must have a correspondingly longer design.

Furthermore, an advantage is that separate handling devices, such as those used in the state of the art to transfer a dental object from one dental machining station to another, are not required. In addition, the transport movement can thus be carried out much faster and time can be saved.

Another advantage is that machine or human errors occurring when the dental object is transferred to different holding units can be completely prevented.

According to an advantageous development, the two dental machining units are based on technologies different from each other, which enable shape cutting, beam cutting, additive manufacturing or marking of the dental object.

According to the invention, each dental machining unit is designed such that it machines the dental object by means of one of the technologies mentioned.

If the dental machining units are based on different technologies, the dental object can advantageously be subject to different processing technologies without tolerances of the position of the dental object relative to the dental object carrier having an adverse effect.

For example, additive processes (e.g., 3D printing with a composite) can be combined with a curing step (e.g., irradiation with UV radiation and/or thermal treatment).

Here, it is particularly advantageous that even a rapid and multiple change of machining units can be carried out without any setup or adjustment measures by the dental machine tool. In this way, faster and more efficient machining of the dental object is made possible.

The shape cutting methods include, in particular, drilling, milling and grinding. It is also possible, for example, to mill in both dental machining units, but to use different milling tools for this purpose. Tool changes that are otherwise common in the state of the art can thus be avoided in certain applications.

All methods which provide a separating treatment of the dental object by means of a fluid medium (particle-containing gas, liquids) or electromagnetic beams (lasers in particular) are considered to be beam cutting methods. These methods (e.g., water jet, sand jet or laser cutting methods) are known as such from the prior art.

All methods which serve to mark the dental object are considered to be marking methods. Marking can be realized as an actual physical marking such as a stamp, brand or engraving marking as well as a digital marking. In a digital marking method, an optical measurement of the dental object can be carried out, for example, and the data obtained from this measurement are used for further processing or checking purposes.

According to an advantageous development, the movable dental object carrier has at least one further movement axis.

This axis can be both a translational and a rotational movement axis. In particular, this advantageous development thus comprises devices by means of which the dental object can be moved on the movable carrier, in particular a carriage, for example pivotably or in a Y axis.

If the movable dental object carrier has at least one further movement axis, more complex dental objects can be machined in a comparatively small machining zone.

For many technologies, it is more convenient to position the dental object under a rigid machining head by means of several movement axes than to equip a machining head with movement means in the corresponding degrees of freedom.

Here, it is particularly advantageous that precision mechanics for the at least one further movement axis only needs to be provided once on the movable dental object carrier and can nevertheless be used for the movement in both dental machining units. Thus, further costs can be saved. Moreover, the effort for separate calibrations in the at least one further movement axis can be avoided, since this at least one further movement axis can also be included in a shared coordinate system of both dental machining units.

According to a next advantageous development, the dental machine tool has more than two dental machining units.

If the dental machine tool comprises more than two dental machining units, the dental object can be subject to further processing steps. For example, mechanical polishing according to the 3D method already mentioned is conceivable.

This makes it particularly advantageous, depending on the degree of complexity, to carry out the entire machining process automatically in only one dental machine tool and with only one clamping.

The invention is described in more detail as an exemplary embodiment on the basis of the following figures:

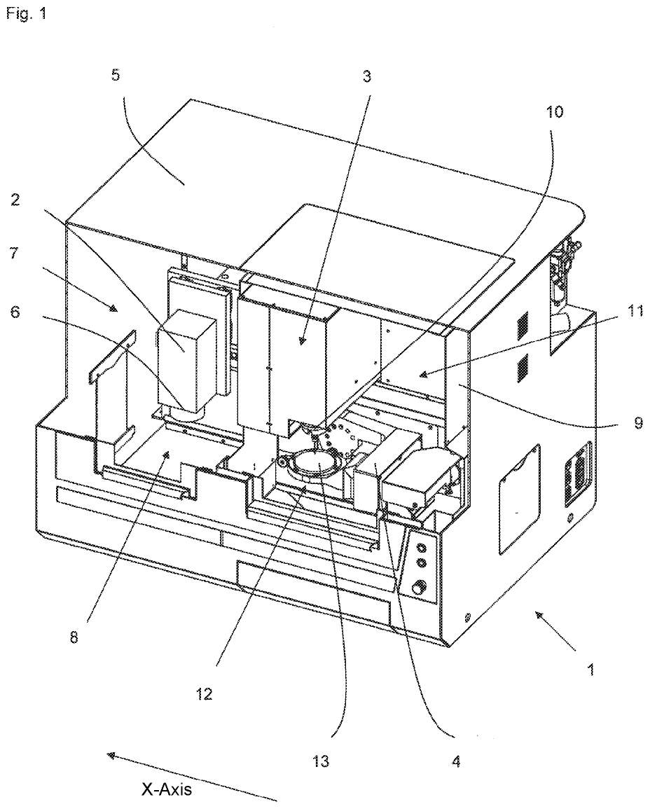

FIG. 1 shows a dental machine tool with position in the second machining zone

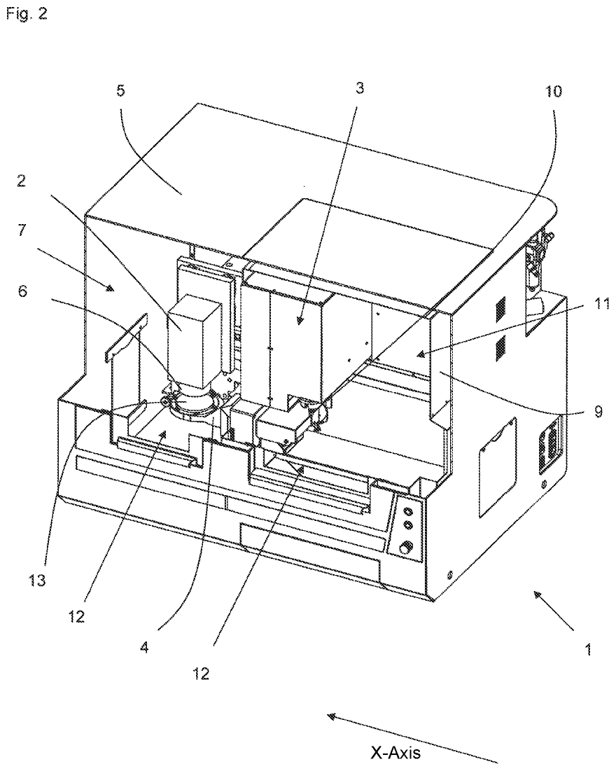

FIG. 2 shows a dental machine tool with position in the first machining zone

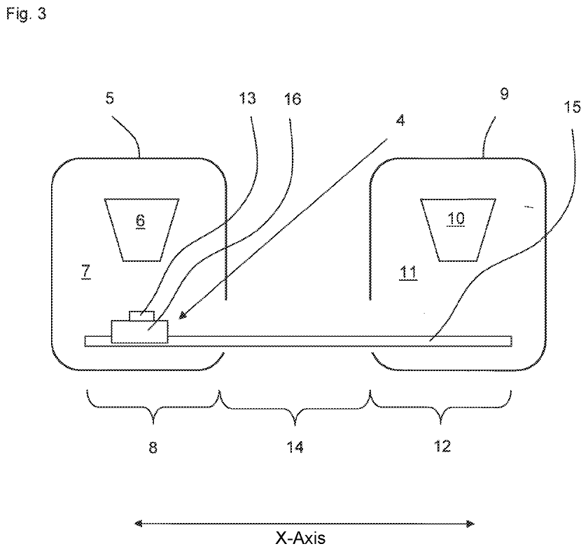

FIG. 3 is a schematic diagram.

FIG. 1 shows the dental machine tool 1 in the position for a machining process carried out in the second machining zone 12.

The dental machine tool 1 has a first dental machining unit 2 and a second dental machining unit 3 as well as a movable dental object carrier 4.

The first dental machining unit 2 has a first housing 5, a first machining head 6, a first machining space 7, and a first machining zone 8.

The second dental machining unit 3 has a second housing 9, a second machining head 10, a second machining space 11, and a second machining zone 12.

The first housing 5 encloses the first machining space 7. The first machining zone 8 is located below the first machining head 6.

In the present exemplary embodiment, the first housing 5 is furthermore designed as a special variant as an outer housing and additionally completely accommodates the second dental machining unit 3. The second housing 9 separates the first machining space 7 from the second machining space 11 in which the second machining head 10 and the second machining zone 12 are located. The second housing 9 is designed by means of an opening such that the movable dental object carrier 4 can move the dental object 13 linearly between the two machining zones 8, 12. For this purpose, the movable dental object carrier 4 is moved along the X axis by means of a guide rail and a carriage.

The movement of the movable dental object carrier 4 in the X axis is additionally shown in FIG. 2. In this figure, the movable dental object carrier 4 has positioned the dental object 13 in the first machining zone 8 of the first dental machining unit 2.

FIG. 3 is a schematic diagram which shows the basic arrangement of the first housing 5 with the first machining head 6 and the first machining space 7 and the second housing 9 with the second machining head 10 and the second machining space 11. The movable dental object carrier 4 carries the dental object 13 and has a linear rail 15 as a stationary linear guide and a linearly movable carriage 16 as a movable carrier.

Furthermore, FIG. 3 shows the basic arrangement of the first machining zone 8, the intermediate zone 14 and the second machining zone 12, along which the linearly movable carriage 16 moves in the X axis. In the first machining zone 8, the first machining movement is carried out, and in the second machining zone 12, the second machining movement is carried out, and in the intermediate zone 14, a transport movement is carried out.

### REFERENCE NUMERALS

1 dental machine tool

2 first dental machining unit

3 second dental machining unit

4 movable dental object carrier

5 first housing

6 first machining head

7 first machining space

8 first machining zone

9 second housing

10 second machining head

11 second machining space

12 second machining zone

13 dental object

14 intermediate zone

15 linear rail

16 linearly movable carriage

1-4. (canceled)

5. A dental machine tool, comprising:
a first dental machining unit having a first housing and a first machining head, the first housing accommodating a first machining space, the first machining head being arranged in the first machining space,
and the first dental machining unit having a first machining zone being allocated to the first machining head;
a second dental machining unit having a second housing and a second machining head, the second housing accommodating a second machining space, the second machining head being arranged in the second machining space, second dental machining unit having a second machining zone being allocated to the second machining head; and
a movable dental object carrier being constructed for receiving a dental object and for moving the dental object linearly along an X-axis, the movable dental object carrier extending over the first machining zone, the second machining zone and an intermediate zone between the first and second machining zones, the movable dental object carrier being constructed for executing:
a first machining movement along the X-axis in the first machining zone;
a second machining movement along the X-axis in the second machining zone; and
a transport movement in the intermediate zone between the machining zones.

6. The dental machine tool according to claim 5, wherein each of the two dental machining units is constructed to machine the dental object with a technology from the group of:
shape cutting;
beam cutting;
additive manufacturing;
curing; and
marking; and
the first and the second dental machining units have technologies different from one other.

7. The dental machine tool according to claim 5, wherein the movable dental object carrier has a further movement axis.

8. The dental machine tool according to claim 5, wherein the dental machine tool has more than two dental machining units.
